(19) United States
(12) Patent Application Publication
(10) Pub. No.: US 2009/0049055 A1
(43) Pub. Date: Feb. 19, 2009

(54) METHOD, APPARATUS, AND SYSTEM TO PROVIDE CONTENT USING CONTENT PREFERENCE INFORMATION

(75) Inventors: Min-ho Lee, Gwacheon-si (KR); Soo-hong Park, Gwangiu-si (KR); Cheol-lu Hwang, Yongin-si (KR); Won-dong Yun, Namyangiu-si (KR); Jeong-rok Jang, Suwon-si (KR); Sang-wook Cho, Suwon-si (KR); Yun-ju Choe, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/102,288

(22) Filed: Apr. 14, 2008

(30) Foreign Application Priority Data
Aug. 16, 2007 (KR) 2007-82285

(51) Int. Cl. G06F 17/30

(52) U.S. Cl. 707/10; 707/E17.108

(57) ABSTRACT

A method, an apparatus, and a system to provide content using content preference information of users, and a computer readable medium to store a computer readable program to execute the content providing method. The method comprises searching the content preference information to identify one of the users that is likely to prefer the content; and transmitting the content to the selected user.

### CROSS-REFERENCE TO RELATED APPLICATION

This application claims the benefit of Korean Application No. 2007-82285, filed Aug. 16, 2007, in the Korean Intellectual Property Office, the disclosure of which is incorporated herein by reference.

### BACKGROUND OF THE INVENTION

1. Field of the Invention

Aspects of the present invention relate to a method, an apparatus, and a system to provide content, using content preference information.

2. Description of the Related Art

FIG. 1 is a signaling diagram of a conventional content providing method. Referring to FIG. 1, the participants associated with the content providing are a content client 10, a content broker 20, and a content provider 30.

The content provider 30 registers a position of content in the content provider 30, in the content broker 20, in operation S10. The content client 10 searches information registered in the content broker 20, in operation S20, and receives a registered position of desired content of the content provider 30, in operation S30.

The content client 10 that found the desired content in the content provider 30 requests the desired content from the content provider 30, in operation S40. The content provider 30 transmits the desired content to the content client 10, in operation S50.

However, due to the development of the Internet and the advances in education, the amount of content that is demanded is rapidly increasing. Thus, various content providing methods are being implemented. In the digital era, methods of providing tangible content using content storage media, such as Compact Discs (CDs), books, newspapers, and methods of providing intangible content, via the Internet, are being popularized.

Accompanying an increase in the amount of content, it is gradually becoming more difficult for the content client 10 to search for a position in which preferred content is located. Although various kinds of search engines and portal sites help to search for the content, by functioning as the content broker 20, it is not easy for massive content to be rapidly delivered to particular users.

With existing content relay systems, it is difficult to accommodate various forms of content. As a result, even if the content provider 30 produces content suitable for a specific user, if the content broker 20 does not provide a proper environment to search for the content, the content client 10 cannot find the suitable content. Thus, the delivery of the content, and the economic activity resulting therefrom, are impeded.

According to an increase in the amount of content, it is gradually getting more difficult to provide a suitable environment to search for content. A certain content provider, such as the content provider 30, which acknowledges this problem, directly transmits or recommends content to the content client 10, through e-mail or a messaging service. However, since this method is applied to unspecified users, the content may be blocked by spam filters.

Thus, a new method of delivering content to desired users is necessary.

### SUMMARY OF THE INVENTION

Aspects of the present invention provide a method, an apparatus, and a system to provide content from a content provider, to a desired user.

According to an aspect of the present invention, there is provided a method of providing content using content preference information, the method comprising: searching for user-related content preference information, and selecting users likely to prefer content that is to be provided; and transmitting the selected content to the selected users.

Aspects of the present invention relate to a method of using a content providing apparatus to search for the user-related content preference information, which is stored in content using apparatuses associated with users, in a peer to peer (P2P) fashion.

Aspects of the present invention relate to a method of providing content comprising: transmitting content preference information from the content using apparatuses, to a content preference information server, which registers the content preference information; and searching the registered content preference information on the content preference information server. The content providing apparatus may comprise: a content preference information server, which transmits a content recommendation to a content using apparatus. The content using apparatus transmits a content request to the content preference information server. The content preference information server transmits the content request to the content providing apparatus. The content providing apparatus transmits content corresponding to the content request message, to the content using apparatus.

According to aspects of the present invention, using the content providing apparatus to transmit the content may comprise: transmitting a content recommendation, which recommends the content to the user, for example, via the content using apparatus; transmitting a content request to the content providing apparatus; and transmitting content corresponding to the content request message, to the content using apparatus.

According to another aspect of the present invention, there is provided an apparatus to provide content according to content preference information, the apparatus comprising: a content preference information search unit to search for content preference information, and to find a user likely to prefer content that is to be provided; and a content transmitter to transmit the content to the user.

According to aspects of the present invention, the content preference information search unit may search content preference information stored in a content using apparatus of a user. The search unit may directly search the content preference information, in a peer to peer (P2P) fashion.

According to aspects of the present invention, the content preference information search unit may search content preference information registered in a content preference information server. The registered content preference information may be content preference information of multiple users, transmitted from content using apparatuses associated with the users.

According to aspects of the present invention, the content providing apparatus may further comprise: a recommendation transmitter to transmit a content recommendation to a content using apparatus; and a content request receiver, to receive a content request from the content using apparatus. The content transmitter transmits content corresponding to the content request, to the content using apparatus.

According to another aspect of the present invention, there is provided a system to provide content according to content preference information, the system comprising: a content using apparatus to store content preference information of one or more users thereof; and a content providing apparatus, which searches the content preference information of each user, identifies a user likely to prefer content that is to be provided, and transmits the content to the content using apparatus, which is associated with the identified user. The content providing apparatus directly searches the content preference information stored in the content using apparatus, in a peer to peer (P2P) fashion.

According to another aspect of the present invention, there is provided a system to provide content according to content preference information, the system comprising: a content preference information server to register content preference information of various users, and to provide a search environment to search the registered content preference information; a content using apparatus to transmit the content preference information to the content preference information server; and a content providing apparatus to search the content preference information, to identify a user likely to prefer content that is to be provided, and to transmit the content to the content using apparatus, which is associated with the identified user.

According to aspects of the present invention, the content preference information server may comprise: a preference information storage unit to receive and store content preference information, of users of the content using apparatus, from the content using apparatus; a preference information analyzer to analyze a content preference information request received from the content providing apparatus, and to identify content preference information corresponding to content that is to be provided by the content providing apparatus, from among the content preference information stored in the preference information storage unit; and a search result storage unit to store the identified content preference information, and to transmit the identified content preference information to the content providing apparatus.

According to aspects of the present invention, the content preference information server may further comprise a preference information crawler to automatically search a content using apparatus of each user, to collect content preference information of each user, and to store the collected content preference information in the preference information storage unit.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the exemplary embodiments, taken in conjunction with the accompanying drawings, of which:

FIG. 1 is a signaling diagram of a conventional content providing device and method;

FIG. 2 is a block diagram of a content providing system, according to an exemplary embodiment of the present invention;

FIG. 3 is a flowchart illustrating a content providing method, according to an exemplary embodiment of the present invention;

FIG. 4 is a block diagram of a content providing apparatus, according to an exemplary embodiment of the present invention;

FIG. 5 is a signaling diagram of a content providing method performed in a content providing system, according to an exemplary embodiment of the present invention;

FIG. 6 is a signaling diagram of a content providing method, according to an exemplary embodiment of the present invention; and

FIG. 7 is a block diagram of a content preference information server, according to an exemplary embodiment of the present invention.

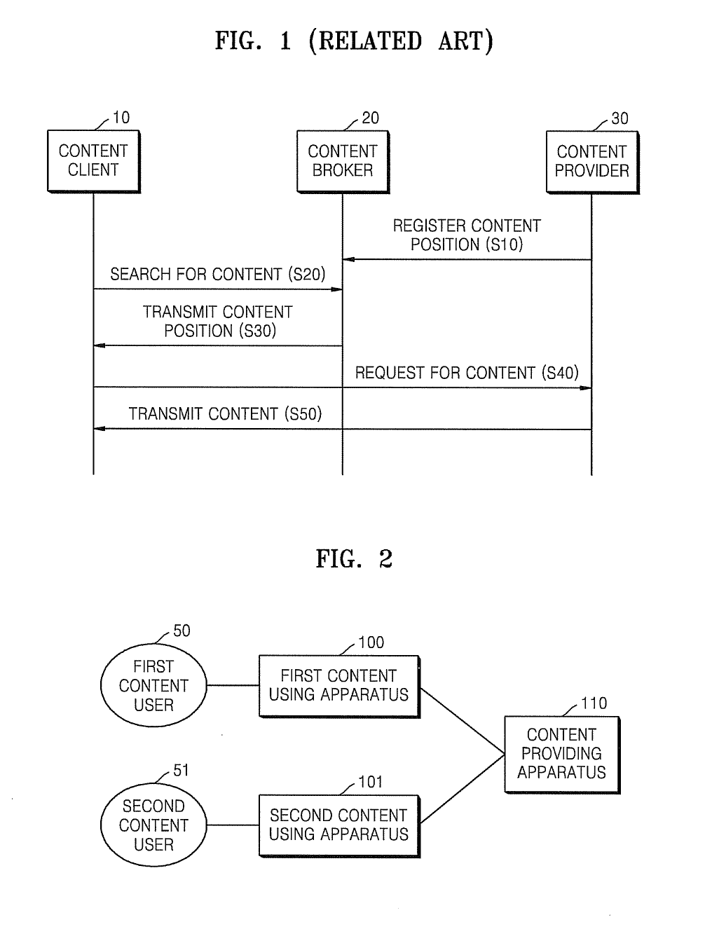

### DETAILED DESCRIPTION OF THE EMBODIMENTS

Reference will now be made in detail to the exemplary embodiments of the present invention, examples of which are illustrated in the accompanying drawings, wherein like reference numerals refer to the like elements throughout. The exemplary embodiments are described below, in order to explain the aspects of the present invention, by referring to the figures.

FIG. 2 is a block diagram of a content providing system, according to an exemplary embodiment of the present invention. Referring to FIG. 2, the content providing system includes a first content using apparatus 100 used by a first content user 50; a second content using apparatus 101 used by a second content user 51, and a content providing apparatus 110. The first content user 50 receives and uses content, by using the first content using apparatus 100, and the second content user 51 receives and uses content, by using the second content using apparatus 101.

According to aspects of the present invention, a content user does not perform a content search. Instead, content preference information of the content user, or users, is continuously updated. For example, the content preference information of the first and second content users 50 and 51 is respectively stored/updated in the first and second content using apparatuses 100 and 101.

The content preference information includes fundamental information and additional information, of each content user. The fundamental information is relatively static statistical information, such as, the age, occupation, sex, and/or region of a user. The additional information is relatively dynamic information, for example content using trends patterns, records, etc., of each content user.

The content using pattern of a content user is continuously updated in the content preference information. The content providing apparatus 110 searches the content preference information stored in the first and second content using apparatuses 100 and 101, in order to match a content user, or users, with a particular type of content that is to be provided. A content provider may use the content preference information to match a particular content with content preferences of users, which are identified through such content preference information, and produce content matching the preferences of the users.

The content providing apparatus 110 searches content preference information stored in the first and second content using apparatuses 100 and 101. In this case, the content providing apparatus 110 directly searches content preference information stored in the first and second content using apparatuses 100 and 101, in a peer to peer (P2P) fashion.

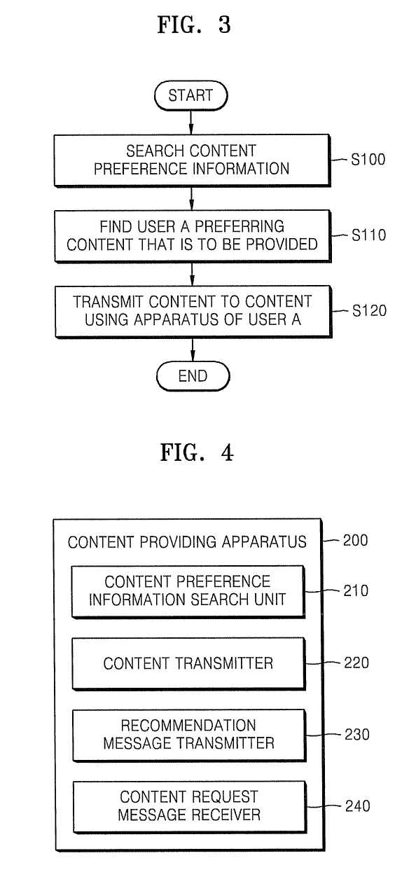

FIG. 3 is a flowchart illustrating a content providing method, according to an exemplary embodiment of the present invention. Referring to FIG. 3, a content providing apparatus 110 searches content preference information related to the first and second content users 50 and 51, in operation S100.

The content providing apparatus 110 searches the content preference information, to identify a user or users, for example a user A, who is likely to prefer content that is to be provided, in operation S110.

The content providing apparatus 110 transmits the content to the user A, in operation S120. For, example, the content can be transmitted to an email account of user A, or directly to a content using apparatus associated with user A.

FIG. 4 is a block diagram of a content providing apparatus 200, according to an exemplary embodiment of the present invention. Referring to FIG. 4, the content providing apparatus 200 includes a content preference information search unit 210, a content transmitter 220, a recommendation transmitter 230, and a content request receiver 240. The content providing apparatus 200 can be used to perform the content providing method illustrated in FIG. 3.

The content preference information search unit 210 identifies a user likely to prefer content that is to be provided, by searching content preference information, which relates to a plurality of users.

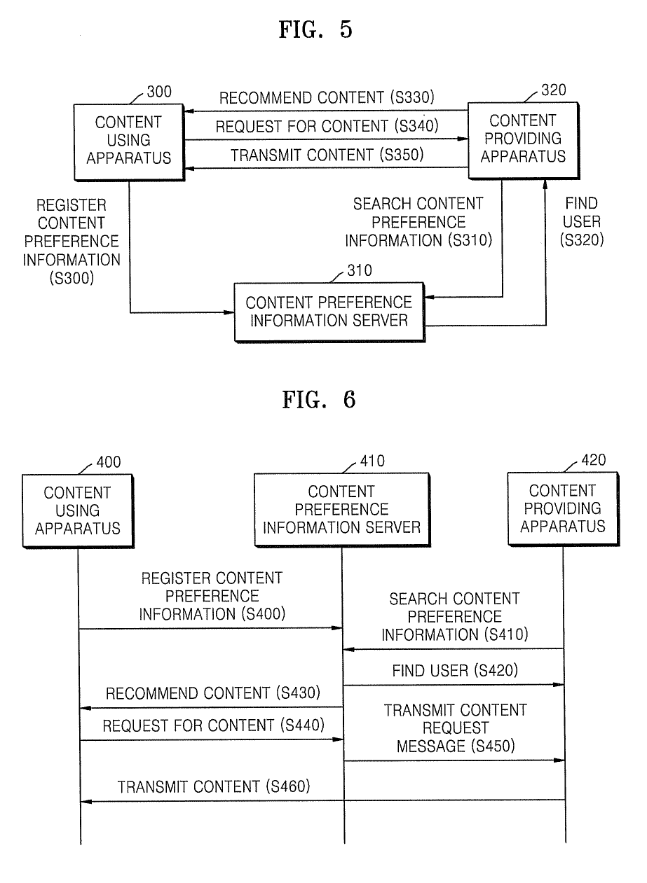

A separate content preference information server may exist, as will be described in more detail with reference to FIG. 5. In an embodiment in which the separate content preference information server exists, the content preference information search unit 210 identifies a user likely to prefer the content by searching content preference information registered in the content preference information server.

The content transmitter 220 transmits the content that is to be provided (content C) to a content using apparatus of the user likely to prefer the content that is to be provided (user A).

According to an exemplary embodiment of the present invention, the content providing apparatus 200 can recommend the content C to the user A, via the content using apparatus of the user A, receive a content request from user A, in response to the recommendation, and transmit the content C to the user A, via the content using apparatus of the user A.

In this embodiment, the recommendation transmitter 230 transmits a content recommendation to the content using apparatus, and the content request receiver 240 receives a content request from the content using apparatus.

FIG. 5 is a signaling diagram of a content providing method using a content providing system, according to an exemplary embodiment of the present invention. The content providing system includes a content using apparatus 300, a content preference information server 310, and a content providing apparatus.

The content preference information server 310 collects and registers content preference information, and provides a search environment to search the registered content preference information. The content providing apparatus 320 searches the registered content preference information in the content preference information server 310.

The content providing apparatus 320 can transmit a user preference search query to the content preference information server 310. The search query can be configured to identify a user likely to prefer content of the content providing apparatus 320. The content preference information server 310 analyzes the received user preference search query, and identifies a suitable user, by searching the content preference information, or by creating and searching relevant statistical data.

The content providing apparatus 320 can create a user preference search query, to identify content the particular users prefer, and can transmit the user preference search query to the content preference information server 310. In response, the content preference information server 310 can provide statistical information, or user preference information requested by the content providing apparatus 320. Examples of a user preference search query are as follows:
(1) What is a type or form of content recently preferred by teenage girls living in Seoul?
(2) What content is most preferred by job hunters?
(3) How has the preference of boys under 12 years old, of a specific TV animation program, changed in comparison to that of 2 years ago?

In these queries, information, such as “teenage girls living in Seoul”, “job hunters”, and “boys under 12 years old”, can be searched for by using the fundamental information described with reference to FIG. 2. In addition, the content preferred by these users can be searched for, by using the additional information, as described with reference to FIG. 2.

A user likely to prefer content that is to be provided can be identified, and the content can be recommended and provided using the following two methods, for example.

According to a first method, as illustrated in FIG. 5, a content using apparatus 300 transmits content preference information, to the content preference information server 310, which registers the content preference information according to user, in operation S300. The content providing apparatus 320 searches the registered content preference information, in operation S310, and identifies a user, or users, likely to prefer content that is to be provided, in operation S320.

The content providing apparatus 320 directly transmits a content recommendation to the content using apparatus 300, in operation S330, receives a content request from the content using apparatus 300, in operation S340, and transmits requested content to the content using apparatus 300, in operation S350.

FIG. 6 is a signaling diagram for describing a second content providing method, according to another embodiment of the present invention. As illustrated in FIG. 6, a content using apparatus 400 registers content preference information, in a content preference information server 410, in operation S400. A content providing apparatus 420 searches the registered content preference information, in operation S410. The content providing apparatus 420 identifies a user likely to prefer content that is to be provided, in operation S420. Operations S400, S410, and S420 generally correspond to operations S300, S310, and S320, of the method of FIG. 5, and thus, a more detailed description of these operations is not described.

Referring again to FIG. 6, the content preference information server 410 transmits content recommendation, to the content using apparatus 400, in operation S430. The content recommendation can include content matched to the content preference information of one or more users. The content providing apparatus 420 can register a Uniform Resource Locator (URL) of the recommended content. The content preference information server 410 can insert the URL into the content recommendation, and then transmit the content recommendation.

The content using apparatus 400 transmits a request for the content, to the content preference information server 410, in operation S440. The content preference information server 410, which has received the content request from the content using apparatus 400, transmits the content request to the content providing apparatus 420, in operation S450. The content providing apparatus 420 transmits content corresponding to the content request, to the content using apparatus 400, in operation S460.

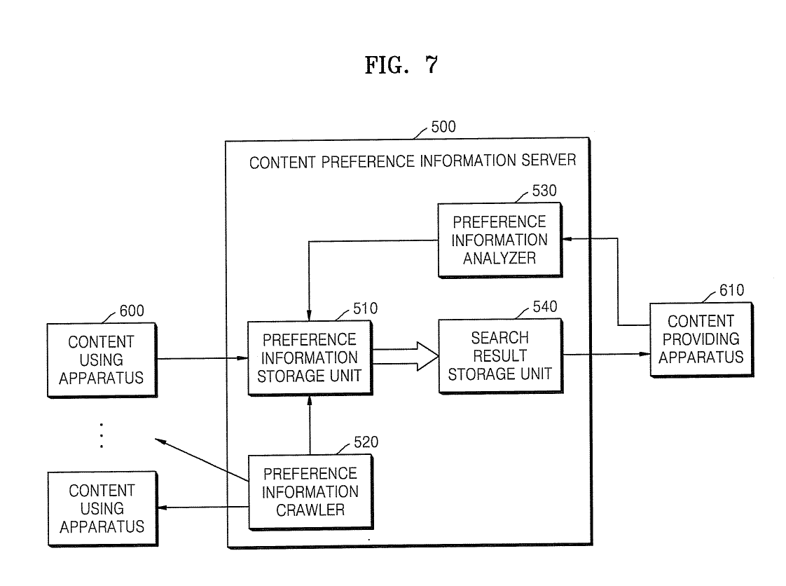

FIG. 7 is a block diagram of a content preference information server 500, according to an exemplary embodiment of the present invention. Referring to FIG. 7, the content preference information server 500 includes a preference information storage unit 510, a preference information crawler 520, a preference information analyzer 530, and a search result storage unit 540. For the convenience of description, a first content using apparatus 600, and a second content providing apparatus 610 are shown in FIG. 7, however, the present invention is not limited thereto, as any number of content using/providing apparatuses can be used.

The preference information storage unit 510 receives and stores content preference information of content users from the content using apparatuses 600. The preference information crawler 520 automatically searches and collects non-registered content preference information, and stores the collected content preference information in the preference information storage unit 510. The preference information crawler 520 can be, for example, a web crawler, which is software operating as a search engine in a server. The web preference information crawler 520 can automatically search and index various pieces of information on the web. A web crawler can be referred to as a spider, a bot, or an intelligence agent.

The preference information analyzer 530 analyzes a content preference information request received from the content providing apparatus 610, and identifies corresponding content preference information (and/or users related thereto), from the content preference information stored in the preference information storage unit 510. An example of the content preference information request is the user preference search query, as described with reference to FIG. 5.

The preference information analyzer 530 can provide information requested by the content providing apparatus 610, by creating statistical data from the content preference information, and/or by analyzing the created statistical data, in response to the user preference search query.

The search result storage unit 540 stores the content preference information, or the statistical data analyzed by the preference information analyzer 530, and transmits the content preference information, or the statistical data, to the content providing apparatus 610.

Aspects of the present invention can also be embodied as computer readable program stored on a computer readable medium. The computer readable medium is any data storage medium that can store data to be read by a computer system. Examples of the computer readable medium include read-only memory (ROM), random-access memory (RAM), CD-ROMs, magnetic tapes, floppy disks, optical data storage devices, etc.

As described above, aspects of the present invention provide a method of providing content using content preference information, in order to solve problems of conventional methods in which a content consumer searches for content.

According to aspects of the present invention, a content provider searches for content consumers (users). Each content consumer provides content preference information, via a respective content using apparatus. A content providing apparatus searches content preference information, which is stored in each content using apparatus, in a P2P fashion, or searches content preference information registered in a content preference information server. Through the search, the content providing apparatus can identify users suitable for content that is to be provided.

As described above, by finding users likely to prefer the content that is to be provided by the content provider, convenience to the users increases, and more suitable content can be provided to the users.

While each content user searches for ready-made content in the conventional methods, in a content providing method, according to aspects of the present invention, a content provider acknowledges the demands of each content user, and produces new content, or builds a system to search for content, and thus, each content user can be greatly satisfied.

A content recommendation is transmitted to the content using apparatus of a user. Thus, a problem in the conventional method, in that content is transmitted or recommended to unspecified users, is solved. That is, user management can be systematically performed.

Although a few exemplary embodiments of the present invention have been shown and described, it would be appreciated by those skilled in the art that changes may be made in these exemplary embodiments, without departing from the principles and spirit of the invention, the scope of which is defined in the claims and their equivalents.

What is claimed is:

1. A method of providing content using content preference information that identifies content preferences of users, the method comprising:
searching the content preference information to identify at least one of the users that is likely to prefer the content; and
transmitting the content to the identified user.

2. The method of claim 1, wherein:
the content preference information is stored in content using apparatuses associated with the users; and
the searching of the content preference information comprises searching the content preference information stored on the content using apparatuses, in a peer to peer (P2P) fashion.

3. The method of claim 1, wherein:
the content preference information is collected from content using apparatuses associated with the users, and registered in a content preference information server; and
the searching of the content preference information comprises searching the registered content preference information.

4. The method of claim 3, wherein the transmitting of the content to the identified user comprises:
transmitting a content recommendation to the identified user;
transmitting a content request from the identified user, to the content preference information server;
transmitting the content request from the content preference information server to the content providing apparatus; and
transmitting a portion of the content, corresponding to the content request from the content providing apparatus, to the identified user.

5. The method of claim 1, wherein the transmitting of the content to the identified user comprises:
transmitting a content recommendation to the identified user;
transmitting a content request from the identified user to the content providing apparatus; and
transmitting content corresponding to the content request from the content providing apparatus, to the identified user.

6. An apparatus to provide content according to content preference information that identifies content preferences of users, the apparatus comprising:
a content preference information search unit to search the content preference information, in order to identify at least one of the users that is likely to prefer the content; and
a content transmitter to transmit the content to the identified user.

7. The apparatus of claim 6, wherein the content preference information search unit searches the content preference information, which is stored in content using apparatuses associated with the users, in a peer to peer (P2P) fashion.

8. The apparatus of claim 6, further comprising a content preference information server to collect and register the content preference information, from content using apparatuses of each of the users.

9. The apparatus of claim 6, further comprising:
a recommendation transmitter to transmit a content recommendation to the identified user; and
a content request receiver to receive a content request from the identified user,
wherein the content transmitter transmits content corresponding to the content request to the identified user.

10. A system to provide content using content preference information, the system comprising:
a content using apparatus to store the content preference information, which relates to users of the content providing apparatus; and
a content providing apparatus to search the content preference information, in order to identify at least one of the users that is likely to prefer the content, and to transmit the content to the identified user,
wherein the content providing apparatus searches the content preference information in a peer to peer (P2P) fashion.

11. A system to provide content using content preference information of users, the system comprising:
a content preference information server to collect and register the content preference information, and to provide a search environment for the registered content preference information;
a content using apparatus to transmit the content preference information to the content preference information server; and
a content providing apparatus to search the registered content preference information, in order to identify at least one of the users that is likely to prefer the content, and to transmit the content to the identified user.

12. The system of claim 11, wherein the content preference information server comprises:
a preference information storage unit to receive and store the content preference information;
a preference information analyzer to analyze a content preference information request received from the content providing apparatus, and to search the stored content preference information to select the content preference information that corresponds to the content; and
a search result storage unit to store selected content preference information and to transmit the selected content preference information to the content providing apparatus.

13. The system of claim 12, wherein the content preference information server further comprises a preference information crawler to automatically collect the content preference information, and to store the collected content preference information in the preference information storage unit.

14. A computer readable medium to store a computer readable program to execute a method of providing content using content preference information of users, the method comprising:
searching the content preference information, in order to identify one of the users that is likely to prefer the content; and
transmitting the content to a content using apparatus of the identified user.

15. The method of claim 1, wherein the searching of the content preference information comprises using a web crawler to automatically search the content preference information.

16. The method of claim 1, wherein the transmitting of the content to the identified user comprises:
transmitting the content to the user, via a content using apparatus associated with the identified user.

17. The method of claim 1, wherein the content preference information comprises:
fundamental information related to each user, which is relatively static; and
additional information of each user, which is relatively dynamic.

18. The system of claim 10, further comprising a plurality of content using apparatuses to store portions of the content preference information, which relate to users of the content providing apparatuses.

19. The method of claim 1, wherein the searching the content preference information comprises identifying ones of the users that are most likely to prefer the content.
